(19) United States
(12) Patent Application Publication
(10) Pub. No.: US 2020/0246113 A1
(43) Pub. Date: Aug. 6, 2020

(54) MULTI-DIRECTIONAL ENDODONTIC INSTRUMENT

(71) Applicant: David Li, Arcadia, CA (US)

(72) Inventor: David Li, Arcadia, CA (US)

(21) Appl. No.: 16/526,014

(22) Filed: Jul. 30, 2019

Related U.S. Application Data
(60) Provisional application No. 62/800,445, filed on Feb. 2, 2019.
(60) Provisional application No. 62/838,220, filed on Apr. 24, 2019.

(51) Int. Cl. A61C 5/42

(52) U.S. Cl. CPC A61C 5/42

(57) ABSTRACT

In aspect, a multi-directional endodontic file in the present invention may include a non-cutting portion, a shaft and a plurality of thin cutting blades branching from the shaft toward different directions. More specifically, the cutting blades are branched from an upper portion, a center portion and a lower portion of the shaft. Comparing with conventional endodontic files having a relatively rigid cutting portion, the endodontic file in the present invention has a hollow structure with a plurality of thin cutting blades extending from the shaft, which conducts the cutting in the root canal more conservatively, and since each cutting blade extends toward different directions, each blade operates independently at different levels.

### FIELD OF THE INVENTION

The present invention relates generally to an endodontic instrument, and more particularly to a multi-directional endodontic instrument to perform root canal therapy and procedures in a tooth.

### BACKGROUND OF THE INVENTION

Conventional endodontic instruments may include a series of solid and round files with constant or varied tapers. The files provide cutting surfaces and cutting edges to remove the contents of a root canal, to create an increasingly tapered aperture in the root canal, and to prepare and/or shape the root canal prior to filling a selected one of a set of variable taper filling materials.

Some conventional root canal instruments have a series of files having various rigid cutting structures of edges, flutes, or flanges along the solid and round shaft from a larger diameter in a shank portion to a smaller diameter in a tip portion to shape and clean a root canal. Rounded tips of the files are designed to eliminate ledging, however, they may not provide an efficient cutting and cleaning.

Although a series of files with varied tapers and sizes can be used, the files with rigid cutting structures along solid and round shaft do not entirely fit the physiological geometries of individual root canals. When a root canal procedure is being performed, the pulp tissue and bacteria must be removed from the root canal of the tooth. Often the canals are curved, thus necessitating a cleaning file, which can bend as it negotiates further into the canal.

Tapered rotating dental endodontic files are used to clean the inside of a root canal in endodontic procedures. Typically, these files are tapered fluted bodies, with spiral fluted cutting surfaces providing a working surface for cleaning the conical interior of a root canal. More recently, rotary endodontic files are made of nickel titanium, a metal alloy that has shape memory and superelasticity. However, nickel titanium files are hard to twist like stainless steel, because like a rubber band they tend to return to their original shape, and will “untwist.” Therefore, production of nickel titanium files involves isolating the pre-fluted file in a stationary position, where grinding wheels are applied to the file, such as CNC (computer numerically controlled) ROLLAMATIC machines.

As shown in FIG. 1, a major problem with mechanically rotated endodontic files is that unless there is a non-cutting surface touching opposite portions of the inside of the canal being routed and cleaned by the rotating file, the file will erratically deviate off center within the canal, sometimes damaging or even perforating through the root canal wall, rendering root canal therapy impossible to achieve and the necessity for extraction of the tooth.

For example, if the diameter of the tapered rotating file is less than the diameter of the portion of the tapered root canal where the working surface of the rotating file is being applied, the file may tend to erratically deflect and cause damage to the root canal wall, possibly permanently damaging the tooth. It is noted that the problem does not only occur among rotating files, it may occur among reciprocating/oscillating files, as well as files operating with ultrasonic energy. Therefore, there remains a need for a new and improved multi-directional endodontic files for root canal therapy to overcome the problems stated above.

### SUMMARY OF THE INVENTION

It is an object of the present invention to provide a multi-directional root canal instrument that is flexible in an axial orientation, from an imaginary or actual center axis to peripheral.

It is another object of the present invention to provide a multi-directional root canal instrument that has a hollow structure with cutting blades branching off a central stem instead of having a large round file with cutting edges on the central stem.

It is still another object of the present invention to provide a multi-directional root canal instrument that has cutting blades cutting/scraping canal walls without removing tooth structure coronal to it, and each blade operates independently at different levels.

It is a further object of the present invention to provide a multi-directional root canal instrument that has cutting blades configured to better collect debris instead of just pushing them around.

It is a still further object of the present invention to provide a multi-directional root canal instrument of which the central stem will not be stuck in canals to avoid breakage.

It is still a further object of the present invention to provide a multi-directional root canal instrument that has a tip portion with branching or mesh cutting blades for better cleaning.

In one aspect, a multi-directional endodontic file in the present invention may include a non-cutting portion, a shaft and a plurality of cutting assemblies, and each cutting assembly has a plurality of thin cutting blades branching from the shaft toward different directions. More specifically, the cutting assemblies are formed at an upper portion, a center portion and a lower portion of the shaft.

Comparing with conventional endodontic files having a relatively rigid cutting portion, the multi-directional endodontic file in the present invention has a hollow structure with a plurality of cutting assemblies with a plurality of cutting blades extending from the shaft, which conducts the cutting in the root canal more conservatively, and since each cutting blade extends toward different directions, each blade is configured to operate on its own at different directions and levels.

Furthermore, even though each cutting blade extends towards different directions from the shaft, each cutting blades extends from substantially the same portion of the shaft collectively forms a nest-like structure, which is configured to better collect debris during the root canal procedure instead of pushing them around.

It is important to note that since the cutting blades is not as rigid as conventional cutting blades of the endodontic file, the shaft is less likely to deviate from the center of the root canal during the cleaning procedure, so the possibility to damage the root canal wall is significantly reduced. Also, the possibility for file breakage can also be reduced.

In another embodiment, a multi-directional endodontic file in the present invention may include a non-cutting portion, a shaft and a plurality of cutting assemblies, and each cutting assembly has a pair of hollow cutting blades branching from the shaft toward different directions. More specifically, the cutting assemblies are formed at an upper portion, a center portion and a lower portion of the shaft.

Like the previous endodontic file in the present invention, the endodontic file also has a hollow structure with a pair of hollow cutting blades extending from the shaft, which conducts the cutting in the root canal more conservatively, and since each cutting blade extends toward different directions, each blade is configured to operate on its own at different levels.

Furthermore, even though each cutting blade extends towards different directions from the shaft, each cutting blades extends from substantially the same portion of the shaft collectively forms a nest-like structure, which is configured to better collect debris during the root canal procedure instead of pushing them around.

Likewise, since the cutting blades is not as rigid as conventional cutting blades of the endodontic file, the shaft is less likely to deviate from the center of the root canal during the cleaning procedure, so the possibility to damage the root canal wall is significantly reduced. Also, the possibility for file breakage can also be reduced.

In a further embodiment, a multi-directional endodontic file in the present invention may include a non-cutting portion, a shaft and a plurality of hollow cutting assemblies, which has a pair of thin cutting blades branching from the shaft toward different directions. More specifically, the cutting blades are formed on the shaft like a brush. The endodontic file can be made by nickel titanium.

In still a further embodiment, a multi-directional endodontic file in the present invention may include a non-cutting portion and a plurality of hollow cutting assemblies, which has a pair of thin cutting blades intertwined with each other to form a lattice structure. The endodontic file can be made by nickel titanium.

In another aspect, a multi-directional endodontic file in the present invention may include a non-cutting portion and a “mesh” cutting assemblies 603 without a central stem. Comparing with conventional files that has defined shape and may be difficult to fit all canal walls, the mesh cutting assemblies is configured to adjust itself to irregular spaces in the canal and engage all the canal walls.

Like the endodontic files illustrated above, the “mesh” cutting assemblies of the multi-directional endodontic file also has a hollow structure and a plurality of cutting blades are formed axially in a “mesh” manner toward different directions even though without a central stem, so each blade is configured to operate on its own at different levels and multiple directions.

Comparing with conventional endodontic files, the present invention is advantageous because of a hollow structure of using thin central shaft and cutting blades to cut tooth structures in a more conservative way, and each cutting blade operates independently at different levels, which avoids removal of unnecessary contents of the root canals and breaking the tooth caused by traditional solid shaft profiles, as well as eliminates ledging, binding, and sticking of the files to the root canals.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 illustrates a prior art of a conventional endodontic file.

FIG. 2 is a drawing illustrating one embodiment of the multi-directional endodontic file in the present invention.

FIG. 3 illustrate another embodiment of the multi-directional endodontic file in the present invention.

FIG. 3a illustrate still another embodiment of the multi-directional endodontic file in the present invention.

FIG. 4 is a drawing illustrating a further embodiment of the multi-directional endodontic file in the present invention.

FIG. 5 is a drawing illustrating an alternative embodiment of the multi-directional endodontic file in the present invention.

FIGS. 6 and 6a-6d illustrate another aspect of the multi-directional endodontic file in the present invention.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

As used in the description herein and throughout the claims that follow, the meaning of “a”, “an”, and “the” includes reference to the plural unless the context clearly dictates otherwise. Also, as used in the description herein and throughout the claims that follow, the terms “comprise or comprising”, “include or including”, “have or having”, “contain or containing” and the like are to be understood to be open-ended, i.e., to mean including but not limited to. As used in the description herein and throughout the claims that follow, the meaning of “in” includes “in” and “on” unless the context clearly dictates otherwise.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the embodiments. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

In order to further understand the goal, characteristics and effect of the present invention, a number of embodiments along with the drawings are illustrated as following:

As stated above, conventional rotated endodontic files may be disadvantageous because unless there is a non-cutting surface touching opposite portions of the inside of the canal being routed and cleaned by the rotating file, the file will erratically deviate off center within the canal, sometimes damaging or even perforating through the root canal wall. Namely, conventional files may tend to erratically deflect and cause damage to the root canal wall, possibly permanently damaging the tooth.

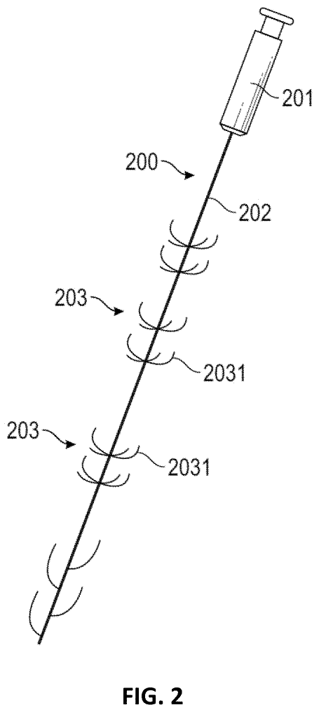

Referring to FIG. 2, in one aspect, a multi-directional endodontic file 200 in the present invention may include a non-cutting portion 201, a shaft 202 and a plurality of cutting assemblies 203, and each cutting assembly 203 has a plurality of thin cutting blades 2031 branching from the shaft 202 toward different directions. More specifically, in one embodiment, the cutting assemblies 203 are formed at an upper portion, a center portion and a lower portion of the shaft 202 as shown in FIG. 2.

Comparing with conventional endodontic files having a relatively rigid cutting portion, the endodontic file 200 in the present invention is relatively flexible in an axial orientation with a hollow structure that has a plurality of cutting assemblies 203 including a plurality of cutting blades 2031 extending from the shaft 202, which conduct the cutting in the root canal more conservatively, and since each cutting blade 2031 extends toward different directions, each blade 2031 is configured to operate independently at different levels and multiple directions. It is noted that each cutting blade 2031 can be used for not only cutting, but scraping, brushing, etc. In one embodiment, the endodontic file 200 can be made by nickel titanium.

Furthermore, even though each cutting blade 2031 extends towards different directions from the shaft 202, the cutting blades 2031 collectively forms a nest-like structure, which is configured to better collect debris during the root canal procedure instead of pushing them around.

It is important to note that the shaft 202 and the cutting blades 2031 are structurally flexible, namely they are not as rigid as conventional endodontic files to prevent the shaft 202 from deviating from the center of the root canal during the cleaning procedure, so the possibility to damage the root canal wall is significantly reduced. Also, the possibility for file breakage can also be reduced.

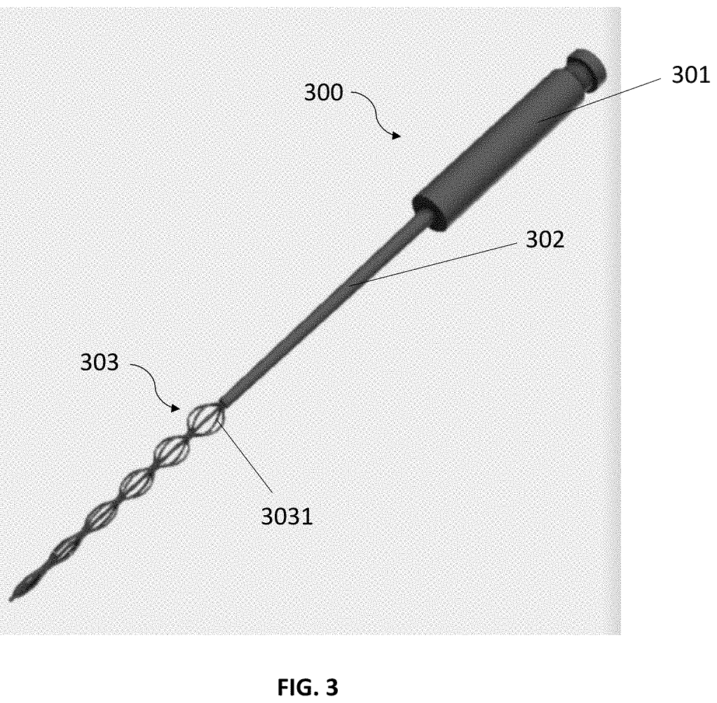

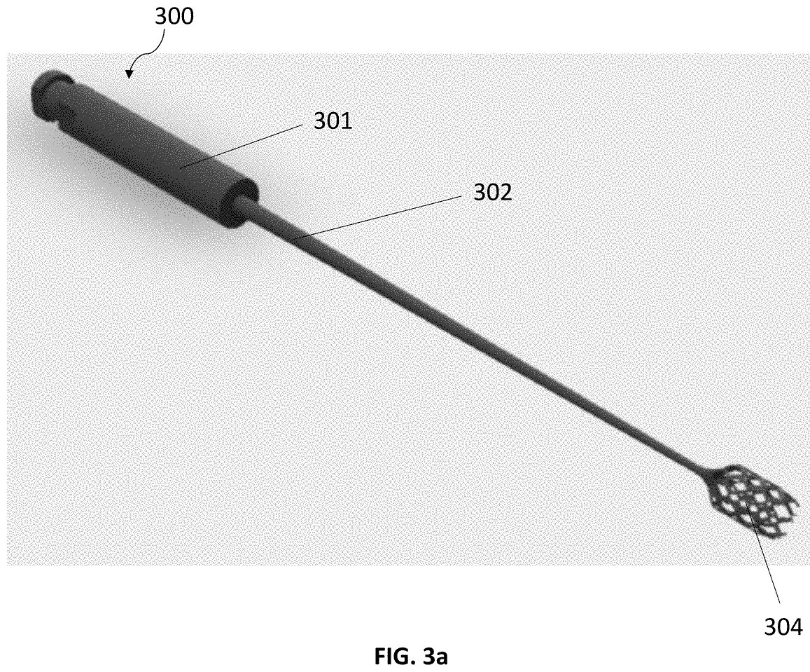

In another embodiment as shown in FIG. 3, a multi-directional endodontic file 300 in the present invention may include a non-cutting portion 301, a shaft 302 and a plurality of hollow cutting assemblies 303, and each cutting assembly 303 has a pair of thin cutting blades 3031 branching from the shaft 302 toward different directions. More specifically, the cutting assemblies 303 are formed at an upper portion, a center portion and a lower portion of the shaft 302 as shown in FIG. 3.

Like the endodontic file 200 in the present invention, the multi-directional endodontic file 300 also has a hollow structure with a pair of hollow cutting blades 3031 extending from the shaft 302, which conducts the cutting in the root canal more conservatively, and since each cutting blade 3031 extends toward different directions, each blade 3031 is configured to operate on its own at different levels and multiple directions. In one embodiment, the endodontic file 300 can be made by nickel titanium.

Furthermore, even though each cutting blade 3031 extends towards different directions from the shaft 302, each cutting blades 3013 collectively forms a nest-like structure, which is configured to better collect debris during the root canal procedure instead of pushing them around.

Likewise, since the shaft 302 and cutting blades 3031 are flexible in an axial orientation, the shaft 302 is less likely to deviate from the center of the root canal during the cleaning procedure, so the possibility to damage the root canal wall is significantly reduced. Also, the possibility for file breakage can also be reduced. It is noted that an end portion 304 of the endodontic file 300 as shown in FIG. 3a has a symmetric and meshed structure that is configured not only to balance the shaft 302, but also to better collect debris during the root canal procedure.

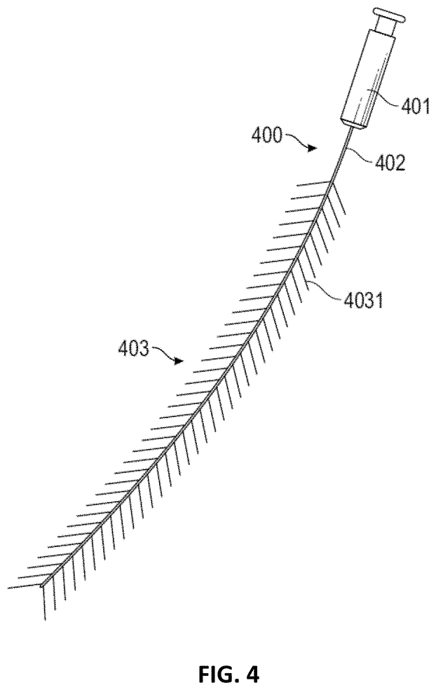

In a further embodiment, a multi-directional endodontic file 400 in the present invention may include a non-cutting portion 401, a shaft 402 and a plurality of hollow cutting assemblies 403, which has a pair of thin cutting blades 4031 branching from the shaft 402 toward different directions. More specifically, the cutting blades 4031 are formed on the shaft 402 like a brush as shown in FIG. 4. The endodontic file 400 can be made by nickel titanium.

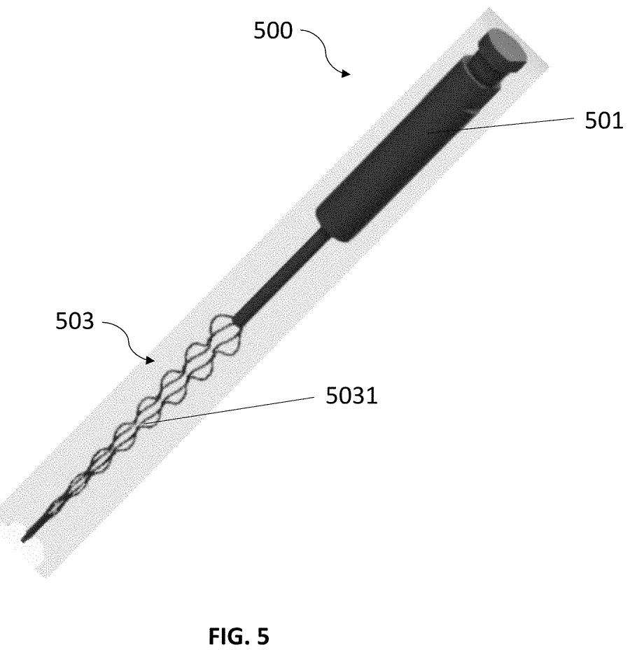

In still a further embodiment, an endodontic file 500 in the present invention may include a non-cutting portion 501 and a plurality of hollow cutting assemblies 503, which has a pair of thin and elongated cutting blades 5031 intertwined with each other to form a lattice structure as shown in FIG. 5. The endodontic file 500 can be made by nickel titanium, for instance. It is noted that the endodontic file 500 does not have a shaft.

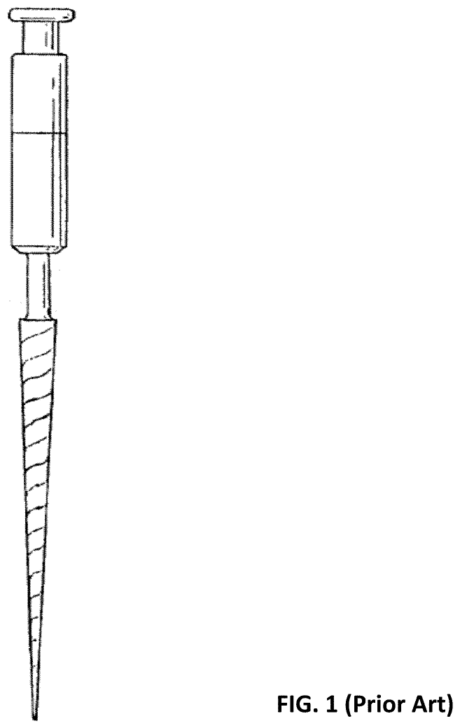

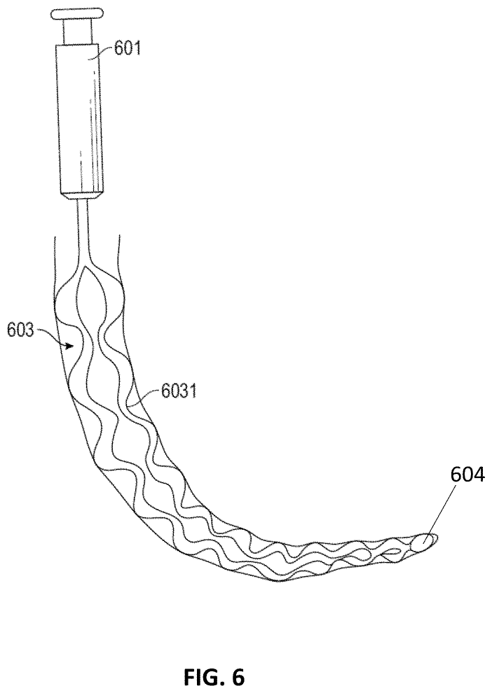

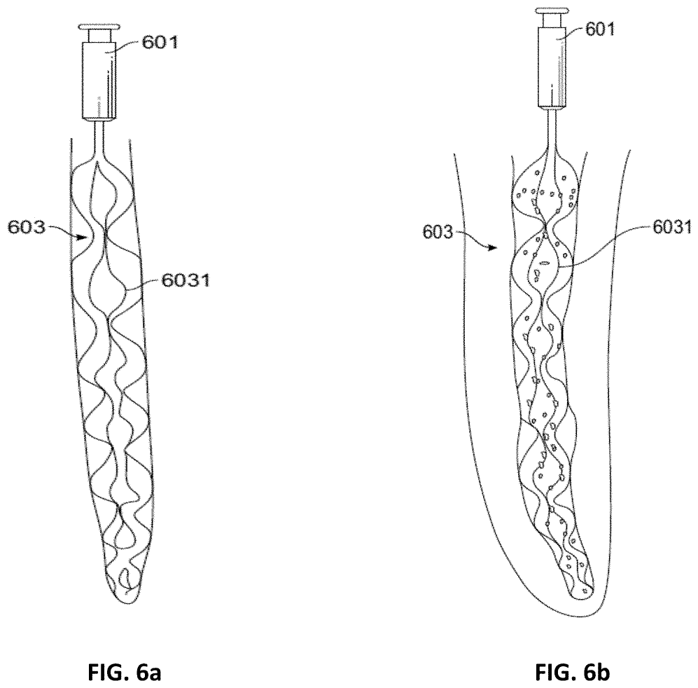

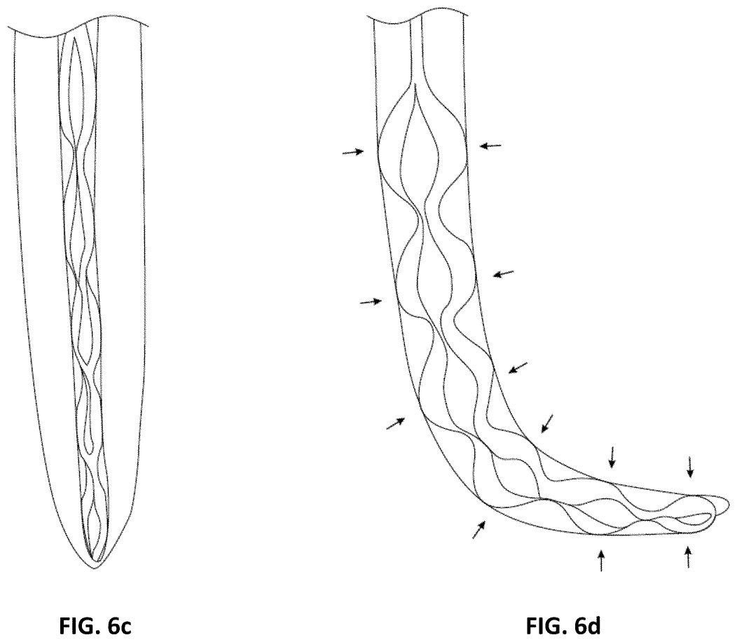

In another aspect, a multi-directional endodontic file 600 in the present invention may include a non-cutting portion 601 and a “mesh” cutting assemblies 603 without a central stem. Comparing with conventional files in FIG. 1 that has defined shape and may be difficult to fit all canal walls, the mesh cutting assemblies 603 is configured to adjust itself to irregular spaces in the canal and engage all the canal walls as shown in FIG. 6.

Like the endodontic files illustrated above, the “mesh” cutting assemblies 603 of the multi-directional endodontic file 600 also has a hollow structure and a plurality of cutting blades 6031 are formed axially in a “mesh” manner toward different directions even though without a central stem, so each blade 6031 is configured to operate on its own at different levels and multiple directions.

Moreover, as shown in FIG. 6a, since the multi-directional endodontic file 600 has the hollow structural cutting assemblies 603, the file 600 can be compressed in the canal in a radial direction to adapt to the canal walls. Also, as shown in FIG. 6b, the hollow structural cutting assemblies 603 allow the irrigation fluid to stay in the canal and does not pack debris against canal walls.

Furthermore, the multi-directional endodontic file 600 also has an expanding apical portion at its apical tip 604 as shown in FIG. 6c to provide better cleaning at the apical portion of canal. Also, as discussed above, the file 600 is in contact with the canal walls so it does not cut selectively, and the file can be kept at a center portion of the canal to avoid transportation as shown in FIG. 6d.

With the hollow structure of the cutting assemblies, the multi-directional endodontic files in the present invention have following advantages comparing with conventional endodontic files, including cutting/scraping canal walls without removing too structure coronal to it, each blade operated independently at different levels and directions, better collecting debris instead of just pushing them around, and avoiding shaft breakage during root canal procedure.

Having described the invention by the description and illustrations above, it should be understood that these are exemplary of the invention and are not to be considered as limiting. Accordingly, the invention is not to be considered as limited by the foregoing description, but includes any equivalent.

What is claimed is:

1. An endodontic instrument comprising:
a non-cutting portion;
a shaft; and
a plurality of cutting assemblies; each cutting assembly having a plurality of cutting blades branching from the shaft toward different directions to be operated independently at different levels and multiple directions used for cutting, scraping, brushing, etc.,
wherein the cutting blades collectively forms a nest-like structure, which is configured to better collect debris during the root canal procedure instead of pushing them around.

2. The endodontic instrument of claim 1, wherein the cutting assemblies are formed at an upper portion, a center portion and a lower portion of the shaft.

3. The endodontic instrument of claim 1, wherein the shaft and the cutting blades are structurally flexible in an axial orientation to prevent the shaft from deviating from a center portion of the root canal during the cleaning procedure.

4. The endodontic instrument of claim 1, further comprising an end portion having a symmetric and meshed structure that is configured not only to balance the shaft, but also to better collect debris during the root canal procedure.

5. The endodontic instrument of claim 1, wherein the endodontic file can be made by nickel titanium.

6. An endodontic instrument comprising:
a non-cutting portion; and
a plurality of cutting assemblies that has a pair of elongated cutting blades intertwined with each other to form a lattice structure to be operated independently at different levels and multiple directions used for cutting, scraping, brushing, etc., and to better collect debris during the root canal procedure instead of pushing them around.

7. The endodontic instrument of claim 6, wherein the endodontic file can be made by nickel titanium.
